(19) United States
(12) Patent Application Publication
(10) Pub. No.: US 2026/0054112 A1
(43) Pub. Date: Feb. 26, 2026

(54) AERIAL FIRE-FIGHTING BUCKET ACTUATION SYSTEMS

(71) Applicant: KAWAK AVIATION TECHNOLOGIES, INC., Bend, OR (US)

(72) Inventors: Andrew SAWYER, Bend, OR (US); Steve SAWYER, Bend, OR (US); Christopher EDWARDS, Bend, OR (US); Scott SIEMSEN, La Pine, OR (US); Scott BOYD, Bend, OR (US)

(21) Appl. No.: 18/812,276

(22) Filed: Aug. 22, 2024

(51) Int. Cl. A62C 3/02; B64D 1/16

(52) U.S. Cl. CPC A62C 3/0235; B64D 1/16

(57) ABSTRACT

A free motion valve system is disclosed. The free motion valve system includes (a) a base platform configured to be attached to a lower opening of a firefighting bucket, the platform having at least one open area configured to allow water to enter and exit the bucket; and (b) a valve assembly including a plate structure configured to move between a closed position in which the plate structure covers the open area and an open position in which water can move through the opening, the valve assembly being configured so that the plate structure moves freely toward the open position in response to upward pressure against a lower surface of the plate structure. Methods of using the free motion valve system with firefighting buckets are also disclosed.

### BACKGROUND

Helicopters are commonly used to fight fires in remote locations, particularly on wildfires. Helicopters are used to drop water and chemical fire retardants on or near the fire. A bucket is suspended from the helicopter using a cargo line, the bucket is filled at remote water locations, and the contents are dropped on the fire, typically by opening a valve at the bottom of the bucket. All of these steps are accomplished without the need to land the helicopter.

Some buckets need to be filled from the top, requiring the bucket to be tipped when placed in water, sometimes via the use of weights applied to one side of the bucket, and in some situations dragged across the surface of the water. Other buckets include valving to allow the bucket to be filled from the bottom, which is typically manually actuated by the operator.

Problems exist with many commercially available systems, including lack of durability of the valve system and issues with actuation of the valve system.

Existing valve designs may have problems with jamming due to debris in the water source, increasing maintenance cost of the bucket and uptime of the aircraft. In some designs, cables and pulleys are used for valve actuation, systems that require significant work to maintain and adjust.

It would be desirable to have valve designs and valve actuation and control systems having enhanced durability in order to increase reliability and availability of the bucket systems. It would also be desirable to have buckets that can easily be filled simply by placing the bucket in a water source without the need for the pilot to perform any activities to ensure the bucket valve is open or is oriented in a way that it will sink or fill with water efficiently.

### SUMMARY

Aerial fire-fighting bucket actuation systems are provided that can be used with buckets that are suspended from a helicopter by a cargo line and used to deliver water to a fire, e.g., a wildfire, from a water source such as a lake, pond, river, or stream. The actuation systems include valve and control systems that enable a bucket to be filled by lowering the bucket into a water source.

In one aspect, the invention comprises a free motion valve system, the system comprising: (a) a base platform configured to be attached to a lower opening of a firefighting bucket, the platform having at least one open area configured to allow water to enter and exit the bucket; and (b) a valve assembly including a plate structure configured to move between a closed position in which the plate structure covers the open area and an open position in which water can move through the opening, the valve assembly being configured so that the plate structure moves freely toward the open position in response to upward pressure against a lower surface of the plate structure.

Some implementations may include one or more of the following features.

The valve assembly may be configured so that the plate structure moves freely towards the closed position in response to the force of gravity, in the absence of a force applied to the lower surface, or in response to pressure exerted upon an upper surface of the plate structure by water in the bucket.

The platform may include a central structure extending upwardly from the platform, the open area comprises semicircular openings disposed on opposite sides of the central structure, and the plate structure comprises a pair of plates positioned to cover the semicircular openings.

The valve system may further include a pair of long arms, each long arm being connected to one of the plates at a proximal end and a distal end of the central structure at a distal end.

The distal ends of the long arms may be slidably connected to the central structure such that the distal ends of the long arms can move upward relatively to the distal end of the central structure as the plates move from the closed position to the open position.

The distal ends of the long arms may include elongated slots, and the distal ends of the long arms may be connected to the central structure by fasteners that are configured to slide in the slots.

The proximal ends of the long arms may be pivotably connected to the plates, or pivotably connected to slotted horizontally extending short arms.

The short arms may be connected to the platform by dog links that permit lateral movement of the short arms.

The valve system may further include an actuator configured to actively move the plate structure from the closed position to the open position. The actuator is not configured to actively move the plate structure from the open position to the closed position.

The actuator may be a linear actuator configured for driven upward movement.

The plates of the valve system may be segmented. Segments of the segmented plates may be connected by a flexible hinge and the segmented plates may be configured to allow the plate structure to be moved to a partially open position.

In another aspect, the disclosure features a method of filling a firefighting bucket with water, the method comprising: (1) attaching to a firefighting bucket skin a valve system comprising (a) a base platform configured to be attached to a lower opening of the firefighting bucket skin, the platform having at least one open area configured to allow water to enter and exit the firefighting bucket; and (b) a valve assembly including a plate structure configured to move between a closed position in which the plate structure covers the open area and an open position in which water can move through the opening, the valve assembly being configured so that the plate structure moves freely toward the open position in response to upward pressure against a lower surface of the plate structure; and (2) placing the base platform of the firefighting bucket in a body of water.

The method may further include removing the bucket from the body of water and allowing the valve assembly to close passively.

The method may also further include actively opening the valve assembly to empty water from the bucket, for example using a linear actuator.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a perspective view of an aerial fire-fighting bucket system according to one implementation.

FIG. 2 is a perspective view of the lower structure of the bucket shown in FIG. 1.

FIG. 3 is a front plan view of the lower structure, with the portion below the valve system removed for clarity and the valve system shown in a closed position.

FIG. 4 is similar to FIG. 3 but shows the valve system in a position in which it is being passively opened by submersion in a water source.

FIG. 5 is similar to FIGS. 3-4 but shows the valve system in a position in which it has been actively opened by a linear actuator, e.g., to dump water from the bucket.

FIG. 6 is similar to FIGS. 3-5 but shows the valve system in a partially open position.

### DETAILED DESCRIPTION

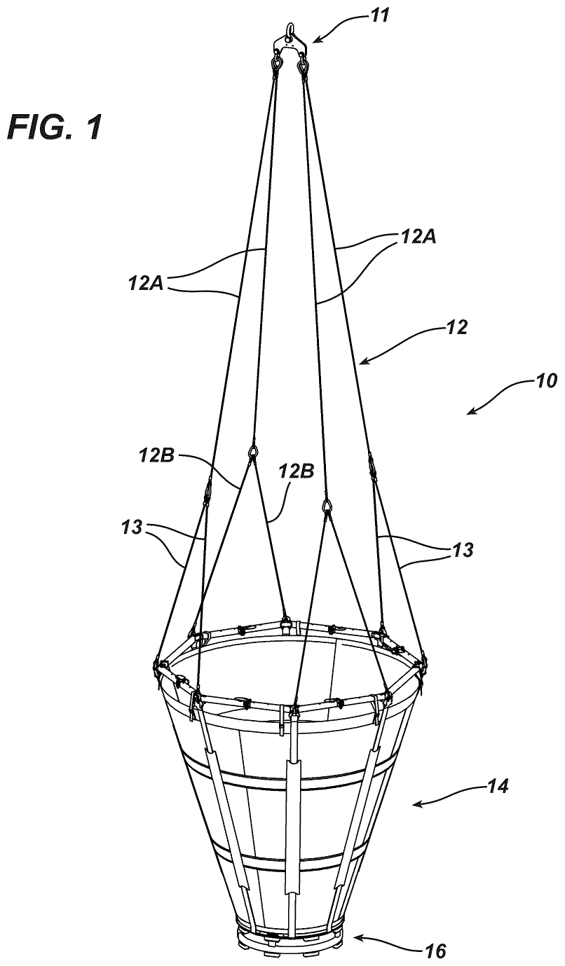

Referring to FIG. 1, an aerial fire-fighting bucket system 10 includes a plurality of rigging cables 12 terminating in a top yoke/shackle 11, a bucket 14, and a lower structure 16. The rigging cables 12 and top yoke/shackle 11 serve to suspend the bucket from a cargo line of an aircraft (e.g., a helicopter), with the top yoke/shackle 11 connecting to the long line hook of the aircraft and the lower ends of the rigging cables 12 being connected to an upper frame of the bucket 14. In the example shown, the rigging cables 12 include a plurality of upper cables 12A, each of which branches into two lower cables 12B. The upper cables 12A and lower cables 12B may be connected using rigging rings 13, to equalize the load and provide necessary movement during use.

The lower structure 16 includes valving to empty the bucket and in some cases supports other optional components within the bucket that provide power filling and supply power to the electrical systems of the bucket system.

An example of a bucket 14 is described in U.S. patent application Ser. No. 17/687,358, filed Mar. 4, 2022, the complete disclosure of which is incorporated herein by reference. However, many other types of buckets and rigging systems can be used with the valving, actuation and control features that will be described herein. The bucket system 10 shown in FIG. 1 is illustrated to provide context for the following description of actuation systems designed for use in firefighting bucket systems.

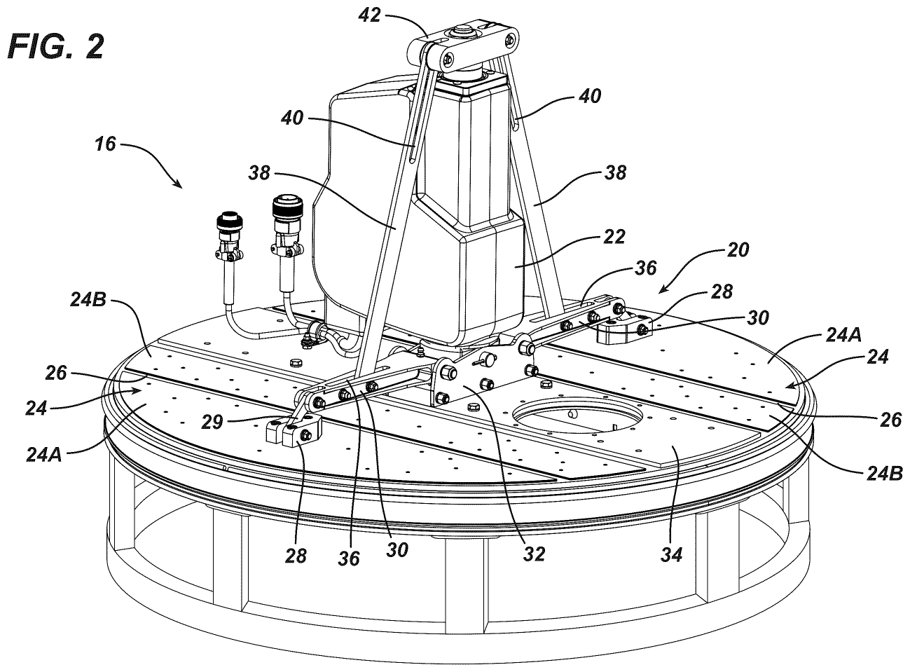

Referring to FIG. 2, the fire-fighting bucket systems described herein include a lower structure 16 that includes a free motion valve system 20 and a submersible actuator 22. The free motion valve system 20 is used to fill the bucket, while the submersible actuator 22 acts to empty the contents of the bucket. These components will now be discussed in detail.

### Free Motion Valve System for Bucket Filling and Emptying

The free motion valve system 20 advantageously opens and closes completely passively, allowing the bucket to easily be filled simply by placing the bucket in a water source. The valve system opens in response to the pressure of the water, without the need for the pilot to perform any activities to ensure the bucket valve is open or is oriented in a way that it will sink or fill with water efficiently. Because the valve also closes passively, in response to the weight of water in the bucket (or gravity if the bucket is empty) the risk of damage to the valve system due to debris in the water is greatly reduced. The structure and operation of the valve system will now be discussed in detail.

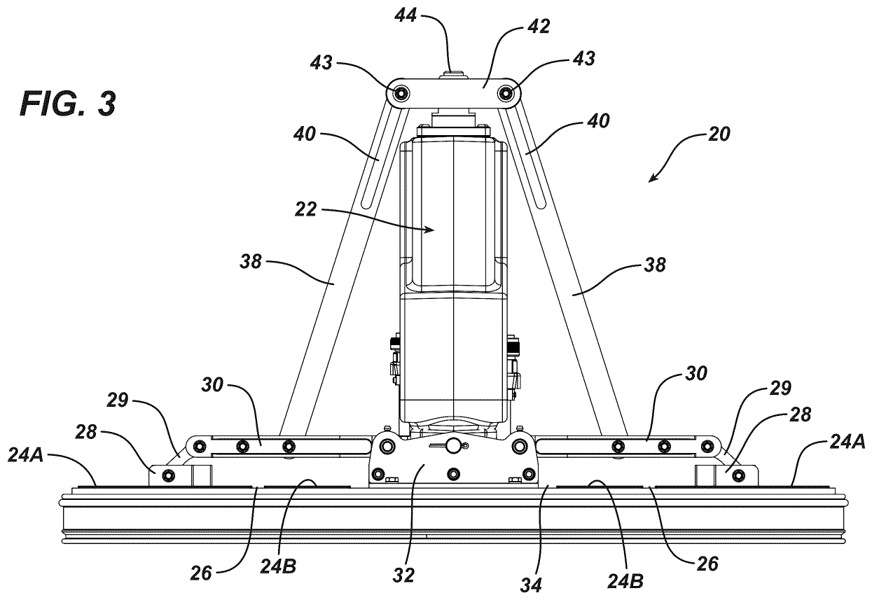

The valve system is shown in its normal, closed position in FIGS. 2 and 3. While in transit to or from a fire the valve remains in this position. When the bucket is full of water the water pressure keeps the valve closed; when the bucket is empty the force of gravity is sufficient to keep the valve closed. The valve is not forced to close by an actuator, as is the case with many commercially available buckets.

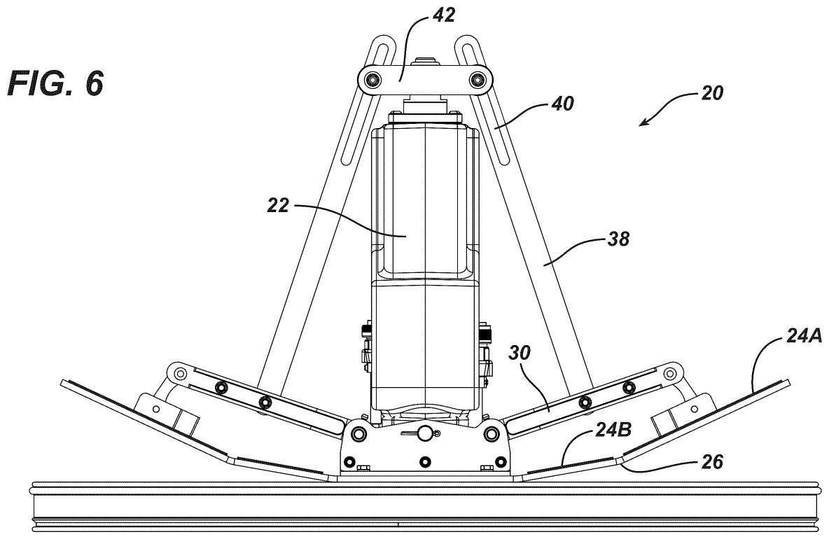

Referring to FIG. 3, the free motion valve system 20 includes a pair of segmented doors 24, each door having an outer section 24A and an inner section 24B, connected by a flexible hinge 26. Similar segmented doors are described in U.S. patent application Ser. No. 17/687,358, incorporated by reference above. The segmentation of the doors allows the doors to be partially opened, e.g., as shown in FIG. 6, by opening only a section of the door area up to a certain angle, reducing load on the actuator 22 when the valve is actuated to empty the bucket. The segmented doors also increase actuation speed and can allow more precise water control during the first part of the valve's travel which can be advantageous for performing smaller water release maneuvers over specific areas.

Referring now to FIGS. 2 and 3, an attachment block 28 is mounted on each outer section 24A. A short arm 30 is attached at one end to each attachment block 28 via a dog link 29, and at the other end to a central actuator base 32. When the valve is closed the short arms 30 extend generally horizontally. Central actuator base 32 is fixedly mounted on a support plate 34.

Each horizontal arm 30 includes a slot 36 in which is pivotably mounted one end of a main arm 38.

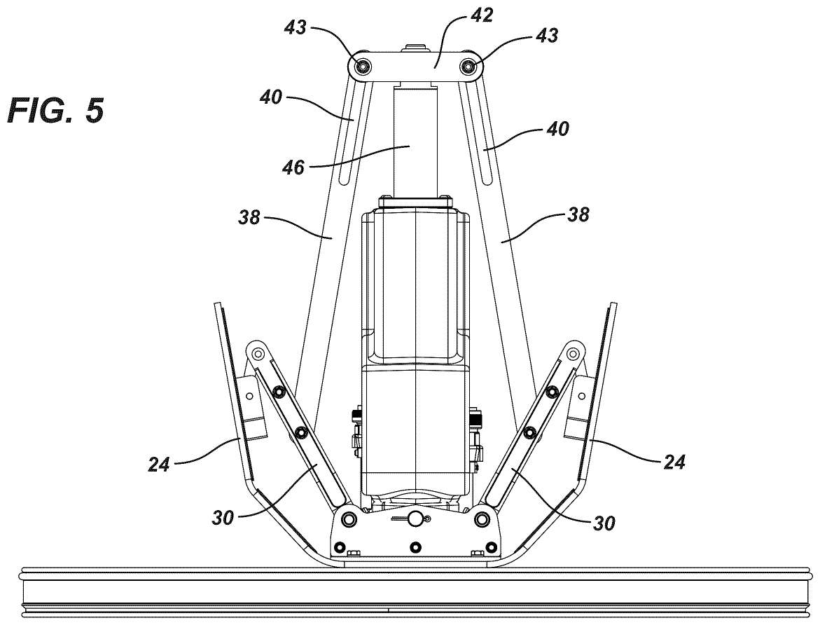

Each main arm 38 includes a slot 40 that allows the main arm 38 to be slidably attached to a horizontal actuator plate 42 by a bolt 43. The actuator plate 42 includes a central aperture (not visible) through which a distal end 44 of a linear actuator rod 46 (FIG. 5) of the submersible actuator 22 extends.

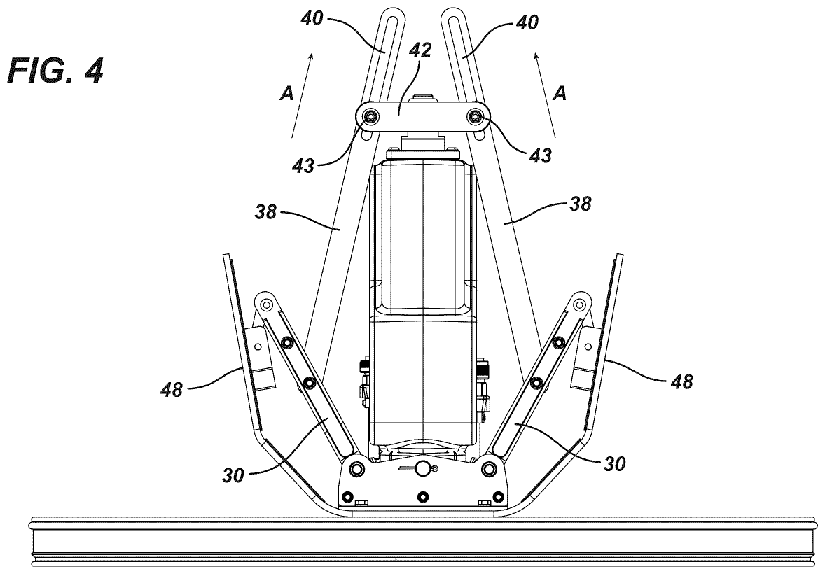

Referring now to FIG. 4, which shows the valve being passively actuated by water pressure, when the bucket is placed in a water source the water presses up against the lower surface 48 of the segmented doors the doors are urged upwards, pressing the short arms 30 upwards which in turn causes the long arms 38 to move upwards (Arrows A, FIG. 4), with the bolts 43 sliding within slots 40. During this movement the lower ends of the long arms 38 pivot within the slots 36 in the short arms 30.

The opening of the valve shown in FIG. 4 occurs automatically when the bucket is lowered into water and is entirely passive. This passive opening does not require any input from the operator other than placing the bucket in a water source and allows the bucket to sink very quickly. Moreover, there is no need to tip the bucket as is the case with top-filling buckets.

As the bucket is lifted from the water, the weight of the water in the bucket pushes the doors closed, returning the bucket to the position shown in FIGS. 2 and 3. This passive closing of the doors is advantageous as compared to designs that actively force the valve to close. Valve designs that actively force the doors to close tend to jam on debris in the water which may damage the sealing surfaces of the doors and/or the actuation mechanism. With the present passive closing design debris can typically be cleared simply by opening the valve and allowing the water to flush out the debris. If this does not work, the bucket can be easily cleaned by the ground support crew without damaging the valve. The simple design of the passive (free motion) valve is also very easy to maintain and durable under challenging field conditions.

### Bucket Actuator

As noted above, the actuator 22 is used to actively open the valve system when water is to be dumped from the bucket. The submersible actuator 22 is fully waterproof and can operate while submerged in excess of 30 feet underwater.

The actuator 22 includes a valve actuator piston 46 (FIG. 5) that is configured for powered linear movement. When the operator is ready to release the water from the bucket, the valve can be opened actively via a low voltage DC signal that is sent through the long line that connects the aircraft to the bucket. When the signal is present, the valve actuator piston 46 will extend and open to its maximum length, as shown in FIG. 5. The bolts 43 remain at the top of the slots 40, i.e., their normal position when the valve is closed, such that the upward pressure of the piston 46 causes the actuator plate 42 to press the bolts 43 up against the top of each slot, lifting the long arms 38 and with them the segmented doors 24. Upward movement of the actuator piston 46 will stop automatically when it reaches the end of its maximum travel. When the signal is removed (typically by un-depressing a momentary switch), the actuator piston 46 will retract and the valve doors will close, returning to the position shown in FIGS. 2 and 3.

### OTHER EMBODIMENTS

A number of embodiments have been described. Nevertheless, it will be understood that various modifications may be made without departing from the spirit and scope of the disclosure.

For example, the systems described herein can include other components, for example a pump for power filling (e.g., as disclosed in U.S. patent application Ser. No. 17/687,358, incorporated by reference above), and/or control systems configured to assist the operator in controlling release of water from the bucket.

Moreover, while an example of a suitable bucket is shown in FIG. 1, the valve systems described herein may be used with many other types of buckets as would be appreciated by those of skill in the art.

Additionally, while the valve system is shown and described above as including a pair of plates arranged around a central actuator, in some implementations the valve system can include a single plate that opens from one side. The same passive opening arrangement would be utilized to allow the plate to move upward in a guided manner in response to water pressure from below and passively close in response to water pressure from above or the force of gravity.

Accordingly, other embodiments are within the scope of the following claims.

What is claimed is:

1. A free motion valve system, comprising:
a base platform configured to be attached to a lower opening of a firefighting bucket, the platform having at least one open area configured to allow water to enter and exit the bucket; and
a valve assembly including a plate structure configured to move between a closed position in which the plate structure covers the open area and an open position in which water can move through the opening, the valve assembly being configured so that the plate structure moves freely toward the open position in response to upward pressure against a lower surface of the plate structure.

2. The valve system of claim 1 wherein the valve assembly is configured so that the plate structure moves freely towards the closed position in response to the force of gravity, in the absence of a force applied to the lower surface, or in response to pressure exerted upon an upper surface of the plate structure by water in the bucket.

3. The valve system of claim 1 wherein the platform comprises a central structure extending upwardly from the platform, the open area comprises semicircular openings disposed on opposite sides of the central structure, and the plate structure comprises a pair of plates positioned to cover the semicircular openings.

4. The valve system of claim 3 further comprising a pair of long arms, each long arm being connected to one of the plates at a proximal end and a distal end of the central structure at a distal end.

5. The valve system of claim 4 wherein the distal ends of the long arms are slidably connected to the central structure such that the distal ends of the long arms can move upward relatively to the distal end of the central structure as the plates move from the closed position to the open position.

6. The valve system of claim 5 wherein the distal ends of the long arms include elongated slots and the distal ends of the long arms are connected to the central structure by fasteners that are configured to slide in the slots.

7. The valve system of claim 4 wherein the proximal ends of the long arms are pivotably connected to the plates.

8. The valve system of claim 7 wherein the proximal ends of the long arms are pivotably connected to slotted horizontally extending short arms.

9. The valve system of claim 8 wherein the short arms are connected to the platform by dog links that permit lateral movement of the short arms.

10. The valve system of claim 1 further comprising an actuator configured to actively move the plate structure from the closed position to the open position.

11. The valve system of claim 10 wherein the actuator is not configured to actively move the plate structure from the open position to the closed position.

12. The valve system of claim 10 wherein the actuator includes a linear actuator configured for driven upward movement.

13. The valve system of claim 3 wherein the plates are segmented.

14. The valve system of claim 13 wherein segments of the segmented plates are connected by a flexible hinge and the segmented plates are configured to allow the plate structure to be moved to a partially open position.

15. A method of filling a firefighting bucket with water, the method comprising:
attaching to a firefighting bucket skin a valve system comprising (a) a base platform configured to be attached to a lower opening of the firefighting bucket skin, the platform having at least one open area configured to allow water to enter and exit the firefighting bucket; and (b) a valve assembly including a plate structure configured to move between a closed position in which the plate structure covers the open area and an open position in which water can move through the opening, the valve assembly being configured so that the plate structure moves freely toward the open position in response to upward pressure against a lower surface of the plate structure; and
placing the base platform of the firefighting bucket in a body of water.

16. The method of claim 15 further comprising suspending the firefighting bucket from an aircraft to deliver water to a fire.

17. The method of claim 15 further comprising removing the bucket from the body of water and allowing the valve assembly to close passively.

18. The method of claim 17 further comprising actively opening the valve assembly to empty water from the bucket.

19. The method of claim 18 wherein actively opening the valve assembly comprises activating a linear actuator.
